(19) United States
(12) Patent Application Publication
(10) Pub. No.: US 2004/0193667 A1
(43) Pub. Date: Sep. 30, 2004

(54) Device for the collective processing of data

(75) Inventor: Denis Lehongre, Pontcharra (FR)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.A., Montrouge (FR)

(21) Appl. No.: 10/743,274

(22) Filed: Dec. 22, 2003

(30) Foreign Application Priority Data
Dec. 23, 2002 (FR) 02 16492

(51) Int. Cl. G06F 17/14

(52) U.S. Cl. 708/400

(57) ABSTRACT

Device for processing digital data and, more particularly, for reading out the maximum or minimum value of data belonging to a set of 2ⁿ codes in which a relation of order is established and in which each of said data has a rank R comprised between 0 and 2ⁿ−1. The device includes a conversion circuit for each digital data to be processed, which circuit generates a transform which is a binary number composed of 2ⁿ−1 binary elements T[x] with x=1 to 2ⁿ−1

T[2ⁿ−1]T[2ⁿ−2] . . . T[x] . . . T[2]T[1]

in which T(x)=0 when x is strictly higher than R and T(x)=1 when x is lower or equal to R. The result of the conversions is received by circuits that carry out a digital processing thereof.

### BACKGROUND OF THE INVENTION

1. Field of the Invention

The present disclosure generally relates to the digital processing of information, and more particularly but not exclusively to a device for the collective processing of large numbers of values and data.

2. Description of the Related Art

With the development of information technologies, the number of data to be processed by systems increases in a constant way. The processing of data is generally carried out within ALU-type (Arithmetic Logic Unit) electronic circuits or within full custom circuits.

When a large number of data must be processed, as is the case, for example, when carrying out the reading out of a maximum value, the processing may become particularly heavy and may require many steps.

FIG. 1 shows a conventional method for reading out the maximum value of a set of Nd values, for example eight values DATA1 through DATA8 (associated with their signals Enable1 through Enable8). To this end, a set of eight elementary functional blocks 11-18 allows the comparison of two values, two by two. Each functional block then provides the maximum value as well as a selection signal Enable_Max, if need be. In such a method, which is of the “compare and forward” type, the processing time is significantly affected since it is necessary to carry out the operations in a serial way, i.e., one after the other. With such a method, the result is obtained, in general, after Nd−1 operations, where Nd represents the number of data to be processed.

According to another known method, reorganizing the various functional blocks in a tree-structured way, as illustrated in FIG. 2, reduces the processing time of the considered operation. It should be noted that, for a set of eight values, not more than three steps are required to carry out the operation because blocks 11, 14, 16 and 18 can start their processing simultaneously.

Although said another known method improves the processing time, the latter remains still high (variable with the Nd logarithm). There are many applications for which it would be desirable to further reduce the collective processing time of the data.

The problem is general and is not limited to the reading out of a maximum value. Many other types of collective processing of data are involved, such as, for example, the reading out of a minimum, the comparison with a target value, etc.

When time constraints become critical, as is the case in large computers having to carry out complex sorting operations, or when real time processing is required, it is necessary to be able to process the data even more quickly than allowed by the known methods.

For these reasons, one cannot in general be satisfied with the possibilities offered by programmable logic units. The realization of specific electronic circuits remains the only possibility of reducing the processing time of a large number of data. However, even with known synthesis tools, it is only possible to generate low performance circuits because the latter implement a method that is substantially the one depicted in FIGS. 1 and 2.

However, maintaining an entirely digital processing of the data, while reducing the calculation time, is desired when a large number of data is to be processed.

### BRIEF SUMMARY OF THE INVENTION

One embodiment of the present invention provides a new architecture for a specialized electronic device making it possible to process a large number of data and to carry out on these data an operation such as, for example, the reading out of a maximum value.

The device of an embodiment of the invention processes a set of digital data belonging to an ordered set in which a relation of order is established and in which each data has a rank R comprised between 0 and 2ⁿ−1. The device comprises:

a conversion circuit for each digital data to be processed, in order to generate a transform which is a binary number composed of 2ⁿ−1 binary elements T[x] with X=1 to 2ⁿ−1:

T[2ⁿ−1]T[2ⁿ−2] . . . T[x] . . . T[2]T[1]

In which T(x)=0 when X is strictly higher than R and T(x)=1 when X is lower or equal to R. Alternatively, a transform is generated which transform is a binary number composed of 2ⁿ binary bits T[x] with X=0 to 2ⁿ−1:

T[2ⁿ−1]T[2ⁿ−2] . . . T[x] . . . T[1]T[0]

The device further comprises circuits for receiving the result of the aforementioned conversions and for carrying out a digital processing of said result.

The transforms that are generated have the special feature of being handled very simply, irrespective of the number of data to be processed.

Indeed, when the digital processing, applied to the set of data to be processed and having undergone the transform, is a Boolean OR carried out in a bit-serial way on the bits of same index and followed by a conversion which is the reverse of said transform, the maximum value of a set of digital values is directly and very quickly obtained.

Conversely, when the digital processing, applied to the set of data to be processed and having undergone the transform, is a Boolean AND carried out in a bit-serial way on the bits of same index and followed by an conversion which is the reverse of said transform, the minimum value of a set of digital values is directly and very quickly obtained.

Alternatively, if one adopts the convention according to which T(x)=1 when X is strictly higher than R and T(x)=0 when X is lower or equal to R, with R being the rank in said ordered set, one then obtains the reading out of the maximum value of the set of data having undergone the transform, by means of a Boolean AND carried out in a bit-serial way on the bits of same index and followed by a conversion which is the reverse of said transform. Instead, with a Boolean OR carried out in a bit-serial way on the bits of same index, in the set of data having undergone the transform, and followed by a conversion which is the reverse of said transform, the reading out of the minimum value is a obtained in a very short time.

It is thus possible to carry out in parallel a large number of operations and no more than three elementary operations are required to extract the maximum or minimum value of a large number of values. Moreover, all kinds of formats can be processed: signed or not signed, with mantissa and exponents, Gray, Johnson etc.

Embodiments of the invention make it possible to realize circuits for reading out maximum and minimum values at a very high speed

### BRIEF DESCRIPTION OF THE DRAWINGS

Other features of embodiments of the invention will appear when reading the following description in relation with the accompanying drawings, given by way of non-restrictive examples only. In the drawings:

FIG. 1 illustrates a first known manner of reading out the maximum value of a set of eight data.

FIG. 2 illustrates a second known manner of reading out the maximum value of a set of eight data.

FIG. 3 illustrates a preferred embodiment of a device for reading out the maximum value of a set of eight data.

FIG. 4 illustrates in detail circuit 209 which carries out the OR combination applied to three values having a 3-bit code.

FIG. 5 illustrates a preferred embodiment of a device for reading out the minimum of a set of eight data.

FIG. 6 illustrate in detail circuit 309 which carries out the AND combination applied to three values having a 3-bit code.

FIG. 7 illustrates, in functional blocks form, the exclusive conditional transcoder for 3-bit codes.

FIG. 8 illustrates the manner of arranging the exclusive conditional transcoders 501 to 507 to carry out the function of reverse transform into T of data having a 3-bit code before conversion thereof into T.

FIG. 9 shows an operation of comparison of equality between a reference value and the transform into T of a value having a 7-bit code.

FIG. 10 illustrates a circuit providing a strictly higher comparison between a reference value (trigger2) and a transform into T of a value having a 7-bit code.

FIG. 11 illustrates a circuit, which is an adaptation of the circuit of FIG. 10, for determining whether a value of a transform into T is higher or equal to another one.

FIG. 12 illustrates a manner of carrying out the transformation into T of data having a 3-bit code.

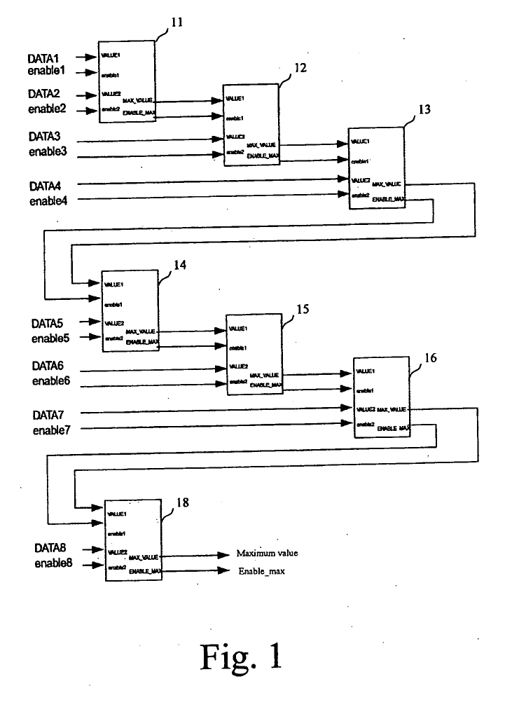

### DETAILED DESCRIPTION

Embodiments of a device for the collective processing of data are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In order to reduce the time for the collective processing of data, there is made use of a conversion function, referred to as “transform into T”, which makes it possible to generate an intermediate coding of each of the DATAx values having to be handled.

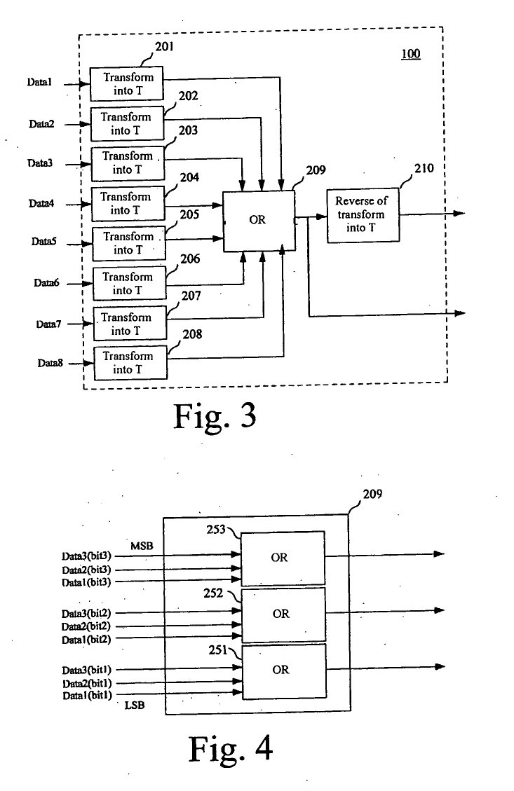

Said conversion function will be used in its first form—which first form is described hereafter—in all of the examples illustrated in FIGS. 3 to 12.

The values B are coded on n bits (i.e., have a n-bit code) and are supposed to belong to an ordered set comprising 2ⁿ elements, in which set a relation of order is established and for which each data has a rank comprised between 0 and 2ⁿ−1. The rank relation between the data to be processed and the transform into T is defined in the following way:

A vector B[n−1] B[n−2] . . . B[2] B[1] B[0] will be transformed into a binary number composed of 2ⁿ−1 bits:

T[2ⁿ−1]T[2ⁿ−2] . . . T[x] . . . T[2]T[1] with x=1 to 2ⁿ−1

In which T(x)=0 when X is strictly higher than R and T(x)=1 when X is lower or equal to R, with R being the rank in said ordered unit, i.e., if the example of decimal values is considered:

R=B[n−1]x2⁽ⁿ⁻¹)+B[n−2]x2⁽ⁿ⁻²⁾+ . . . +B[2]x2²+B[1]x2¹+B[0]x2⁰

It should be noted that such a definition of rank R confers on the present transform into T the following features: firstly, there is a bijective relation between the binary code and its transform into T; secondly, any binary bit T(x) of the transform into T has a value of 1 only when the bits of lower weight have also a value of 1.

Thus, for data having a 3-bit code, there will be the following correspondences:

| Initial binary code | Transform into T | Rank |
|---|---|---|
| 000 | 0000000 | 0 |
| 001 | 0000001 | 1 |
| 010 | 0000011 | 2 |
| 011 | 0000111 | 3 |
| 100 | 0001111 | 4 |
| 101 | 0011111 | 5 |
| 110 | 0111111 | 6 |
| 111 | 1111111 | 7 |

FIG. 3 shows a circuit for the collective processing of digital data in accordance with an embodiment of the invention, which allows, for illustration purposes, the reading out of the maximum value of a set of 8 values DATA1-DATA8 of any kind. It should be noted that the circuit of FIG. 3 is only an example among many and that the man skilled in the art having the benefit of this disclosure will be able without difficulty, to adapt an embodiment to the execution of any other processing operation of any set of values of any kind, such as, without limitation, the reading out of a minimum value or any other operation in which a large number of values is to be processed.

It should be also noted that the number of values is not limited to 8 but, instead, can be any number. Moreover, the data can be expressed under any format, signed or not, provided, however, they constitute a set in which a relation of order is defined.

It may be envisaged to use a second type of transform into T. Said second type of transform into T is based on the previously defined rank relation; its decimal value “0” is transformed into a sequence of “0” with the least significant bit (LSB) set to 1. For illustration purposes, it will be shown, hereafter, the correspondence between values each having an initial 4-bit code and the codes obtained after application of said second type of transform into T to said values.

| Initial | | |
|---|---|---|
| binary code | Transform into T | Rank |
| 0000 | 0000000000000001 | 0 |
| 0001 | 0000000000000011 | 1 |
| 0010 | 0000000000000111 | 2 |
| 0011 | 0000000000001111 | 3 |
| 0100 | 0000000000011111 | 4 |
| 0101 | 0000000000111111 | 5 |
| 0110 | 0000000001111111 | 6 |
| 0111 | 0000000011111111 | 7 |
| 1000 | 0000000111111111 | 8 |
| 1001 | 0000001111111111 | 9 |
| 1010 | 0000011111111111 | 10 |
| 1011 | 0000111111111111 | 11 |
| 1100 | 0001111111111111 | 12 |
| 1101 | 0011111111111111 | 13 |
| 1110 | 0111111111111111 | 14 |
| 1111 | 1111111111111111 | 15 |

Alternatively, if one adopts the convention according to which T(x)=1 when X is strictly higher than R and T(x)=0 when X is lower than or equal to R, with R being the rank in said ordered set, one then obtains the reading out of the maximum value by means of a Boolean AND carried out in a bit-serial way on the bits of same index and followed by a conversion which is the reverse of said transform. Instead, with a Boolean OR carried out in a bit-serial way on the bits of same index and followed by a conversion, which is the reverse of said transform, the reading out of the minimum value is obtained in a very short time.

As it will appear hereafter, the transform into T is suitable for many data combinations and data handling operations.

When considering the first definition of the transform into T (i.e., the one according to which the decimal ‘0’ corresponds to transform “000000 . . . 00”), it should be noted that the rank of the converted value is directly obtained by adding the various binary elements contained in said converted value.

R=T[2ⁿ−1]+T[2ⁿ−2]+T[2ⁿ−3]+ . . . +T[2]+T[1]

Moreover, such transformation into T can be used very advantageously to produce circuits allowing collective processing of data at ultra-high speed. Such circuits constitute a new class of electronic circuits designed either manually or by means of a compilation and logical synthesis tool.

Referring again to FIG. 3, it should be noted that each of the eight values DATA1 with DATA8 is transmitted to the input of a conversion circuit, 201 to 208 respectively, which provides at its output the transform into T corresponding to the value.

The eight values are then transmitted to a conversion circuit 209 which carries out a logical OR—in a bit-serial way on the bits of same index—between the various values provided by blocks 201 to 208.

FIG. 4 illustrates such a conversion circuit in connection with three values having 3-bit codes. But clearly, the man skilled in the art having the benefit of this disclosure will be able to adapt an embodiment to the processing of any number of values having a code with any number of bits. Circuit 209 then outputs a value, which is transformed by a conversion circuit 210 carrying out the reverse of conversion into T.

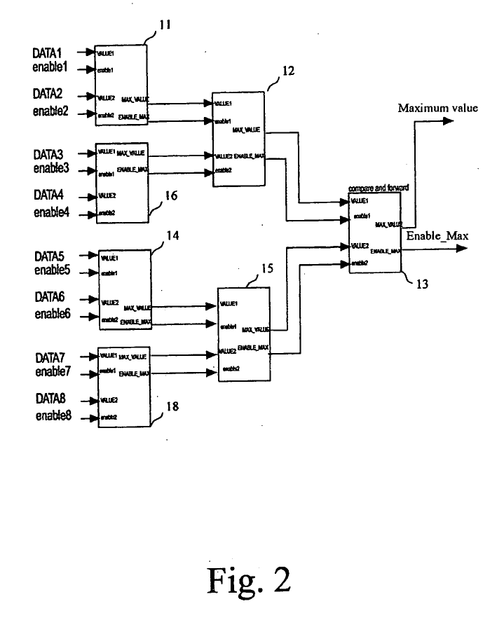

It should be noted that with the device of FIG. 3, all conversions into T can be carried out simultaneously and that, consequently, the processing of the eight values can be completed in only three steps. It should be noted also that, contrary to the conventional techniques, such as the one discussed in reference to FIG. 2, the number of steps no longer depends on the number of values to be processed and that the processing of 128 values, for example, requires no more than 128 circuits of conversion into T.

The reading out of the maximum value of a set of data is thus carried out in an extremely fast way. With one embodiment of the invention, the larger the number of data to be processed, the higher the processing timesaving.

The conversion circuits 201-208, 209 and 210 are integrated in the same semiconductor circuit in an embodiment. The ultra-high speed processing involves an increase in surface, which increase is proportional to the number of bits of the values to be processed. Thus, to process 8-bit values, one embodiment has transforms into T generating words of 2⁸ or 2⁸−1 bits, namely 256 or 255 bits.

The transform into T defined previously tends to generate codes having a great number of bits. Consequently, arithmetic and logic units (ALUs) capable of processing simultaneously enough binary values are used. The correspondence between the number of bits of the data to be processed and the number of bits of the values generated by the transform into T is given below:

| | Number of bits generated |
|---|---|
| Number of bits: | by the transform into T: |
| 4 | 15 (or 16) |
| 5 | 31 (or 32) |
| 6 | 63 (or 64) |
| 7 | 127 (or 128) |
| 8 | 255 (or 256) |
| 9 | 511 (or 512) |
| 10 | 1023 (or 1024) |
| ... | ... |
| N | 2ⁿ −1 (or 2ⁿ) |

Clearly, a compromise between the size of the realized circuit and its speed performances can be reached. In one embodiment, the data to be processed are split into groups of Nb bits, in order to allow the production of intermediate values of 2^{Nb}−1 bits for example, by means of intermediate transforms into T. Once the group containing the bits of highest weights is processed, the next not yet processed group of Nb bits of highest weights is processed. It is thus possible to obtain gradually the reading out of the maximum value, with a limited number of operations and still more quickly than with the conventional techniques.

In practice, one may decide to process only values having four bits, for example. This will lead to the generation of transform into T having 16 bits that will be easy to handle. If the processing of values having more than four bits is desired, then, each value to be processed will be split into 4-bit words and the conversion into T will be applied to each word. It should be noted that, in so doing, a serial processing is re-introduced in the data processing method. Said serial processing, although allowing a reduction in the number of bits and a correlative reduction in the semiconductor surface, entails an increase in the processing time which processing time, however, remains shorter than that obtained when using the known solutions.

FIG. 4 illustrates a conversion circuit 209 making it possible to carry out the logical OR combination, in a bit-serial way on the bits of same index, of three data each having a 3-bit code. Circuit 209 outputs a vector coded on three bits OR[3] OR[2] OR[1]. Each of the three data is coded on three bits: DATA3[3] DATA3[2] DATA3[1] (DATA2[3] DATA2[2] DATA2[1]; DATA1[3] DATA1[2] DATA1[1], respectively). This operation is carried out by means of three logical OR circuits 251, 252 and 253, each having three inputs. Logical OR circuit 251 (252; 253, respectively) has a first input connected to DATA1[1] (DATA1(2); DATA1(3), respectively), a second input connected to DATA2[1] (DATA2(2); DATA2(3), respectively), a third input connected to DATA3[1] (DATA3(2); DATA3(3), respectively) and an output connected to OR[1] (OR[2] OR[3], respectively). It is apparent that the man skilled in the art will be able to make the adaptations required if the processing of any number of values, having a code with any number of bits, is desired.

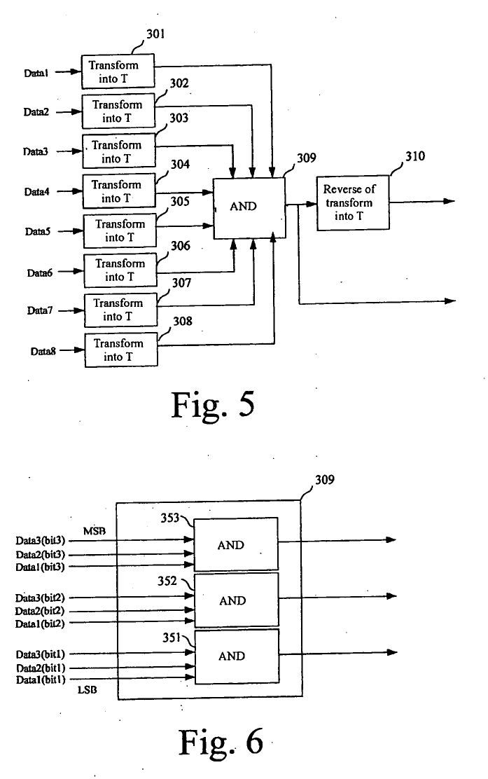

FIG. 5 illustrates an embodiment of a device for reading out the minimum value of a set of data. Each of the eight values DATA1 with DATA8 is transmitted to the input of a conversion circuit, respectively 301 to 308, which outputs the transform into T corresponding to the value.

The eight values are then transmitted to a conversion circuit 309, which carries out a logical, AND combination, in a bit-serial way on the bits of same index, of the various values provided by blocks 301 to 308. Circuit 309 then outputs a value, which is transformed by a conversion circuit 310 that realizes the reverse of conversion into T.

It should be noted again that the reading out of the minimum value of any set of data is obtained in a particularly short time. It is thus possible to envisage all kinds of applications, such as real time processing, even in a particularly critical context.

FIG. 6 illustrates a conversion circuit 309 for an application limited to three values of three bits. Conversion circuit 309 carries out a logical AND combination, in a bit-serial way on the bits of same index, of three data each having a 3-bit code three bits and outputs a vector coded on three bits ET[3] ET[2] ET[1]. Each of the three data is coded on three bits: respectively DATA3[3] DATA3[2] DATA3[1], DATA2[3] DATA2[2] DATA2[1] and DATA1[3] DATA1[2] DATA1[1]. This operation is carried out by means of three logical AND circuits 351, 352 and 353 each having three inputs. Logical AND circuit 351 (352, 353, respectively) has a first input connected to DATA1[1] (DATA1(2); DATA1(3), respectively), a second input connected to DATA2[1] (DATA2(2); DATA2(3), respectively), a third input connected to DATA3[1] (DATA3(2); DATA3(3), respectively) and an output connected to ET[1] (ET[2] ET[3], respectively).

The structure of conversion circuit 210 or 310 may be any structure capable of realizing a conversion that is the reverse of transform into T in the following two steps:

The first step takes the form of an exclusive conditional transcoding in which the binary elements of the element to be transcoded are processed two by two. The output of this first step is a matrix cond_transcode made up of k vectors, with each vector comprising n binary elements.

The second steps comprises reducing all the vectors of the matrix cond_transcode to a single vector, by means of a logical OR combination carried out in a bit-serial way on the bits of same index, which single vector is the value obtained after the conversion which is the reverse of transformation into T.

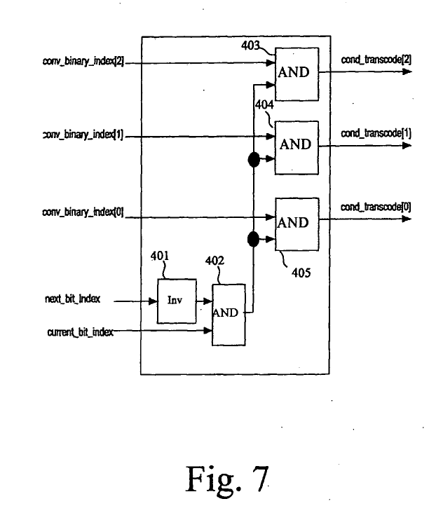

FIG. 7 illustrates, in functional block form, the exclusive conditional transcoder for 3-bit codes. The comparison of the two adjacent binary elements—(i.e., next_bit_index and current_bit_index) is carried out by means of an AND gate 402 and of an inverter 401. The value of next_bit_index is transmitted to inverter 401 whose output is connected to a first input of AND gate 402 whose second input receives the value of current_bit_index. The output of AND gate 402 is transmitted to a first input of a set of three AND gates 403, 404, 405, each having a second input respectively receiving a vector coded on 3 bits (i.e., conv_bin_index[0] to conv_bin_index[2], respectively). At its output, the exclusive conditional transcoder provides three binary elements, namely code_transcode[0] to code_transcode[2], respectively.

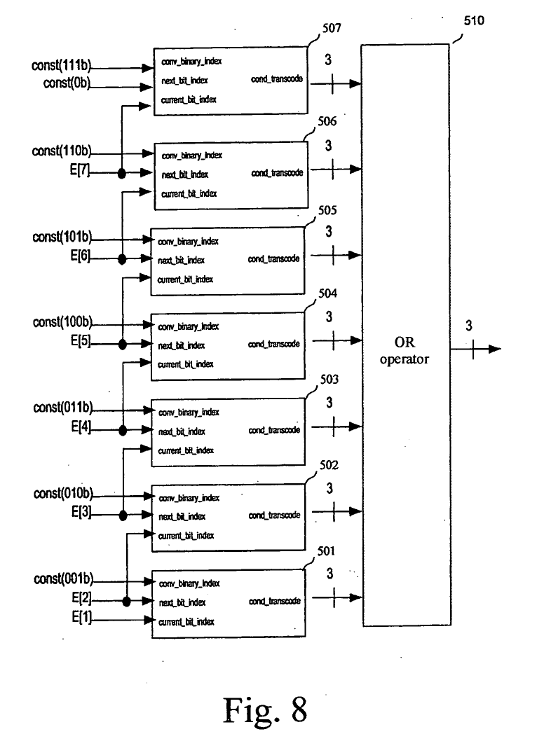

FIG. 8 illustrates the manner of arranging the exclusive conditional transcoders 501 to 507 to realize the conversion which is the reverse of transform into T of a value coded on seven bits, respectively E[1] in E[7]. Seven constants represented by binary values coded on 3 bits and the largest index of which is on the left, namely const(001b) const(010b) const(011b) const(100b) const(101b) const(110b) const(111b), are directed towards the input vectors conv_bin_index of transcoder 501 to 507, respectively. The inputs next_bit_index of the transcoders 501 to 506 respectively receives the element E[2] to E[7]. Element E(1), as for it, is transmitted to the input current_bit_index of transcoder 501. A binary constant coded on one bit, equal to logical ‘0’ and named const(0b), is transmitted to the input next_bit_index of transcoder 507. Each input next_bit_index of a transcoder 501 to 506, respectively, is connected to the input current_bit_index of transcoders 502 to 507, respectively. The outputs of transcoders 501 to 508 are then applied to a Boolean operator OR 510, which realizes the logical OR combination, in a bit-serial way on the bits of same index, and outputs the value of the reverse of transform into T, under the form of a 3-bit code.

Generally, one may consider any manner of realizing converter circuits 301-308 for the transformation into T, and circuit 310 for the reverse operation.

Once the values to be processed are converted according to the transform into T, it becomes very easy to carry out all kinds of operations.

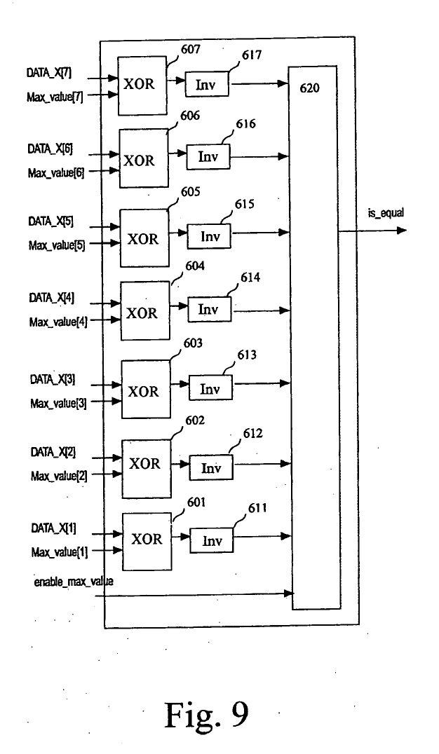

FIGS. 9 to 11 illustrate examples of operations that can be performed on the transforms into T. One will note, again, that the processing of a value transformed into T can be carried out in a very short time.

FIG. 9 shows an operation making it possible to make a comparison of equality between the transform into T of a value and a reference value, for example the maximum value calculated previously. As it can be seen, each binary element of the transform into T, coded on seven bits, (respectively DATAX[1] to DATAX[7]) is transmitted to an input of an exclusive OR gate (601 to 607, respectively) whose second input receives a value of reference coded on seven bits (respectively Max_value[1] to Max_value[7]). The output of each exclusive OR gate is connected to an inverter (611 to 617, respectively) whose output is transmitted to an input of a AND gate 620 whose eighth input receives an enabling signal named enable_max_value. AND gate 620 provides an output signal is equal which is the result of the comparison of equality between the transform into T of the value to be compared (DATAX[1] to DATAX[7], respectively) and said value of reference (Max_value[1] to Max_value[7], respectively).

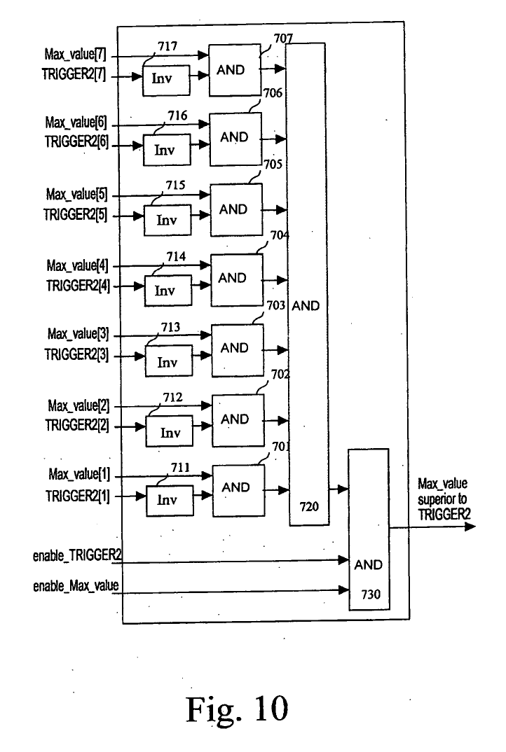

FIG. 10 illustrates an operation of comparison of strict superiority of a transform into T coded on seven bits (for example the maximum value read out before) with a reference value (trigger2). Each binary element of the transform into T to be processed—i.e., Max_value[1] to Max_value[7]—is transmitted to a first input of a AND gate (701 to 707, respectively) having a second input connected to the output of an inverter (711 to 717, respectively), which inverter has an input receiving a reference value (trigger2[1] to trigger2[7], respectively). AND gates 701 to 707 have each an output which is connected to an input of a AND gate 720 which has an output connected to a first input of a AND gate 730, whose two other inputs receive the signals ENABLE of the two compared values (enable_max_value and enable_trigger2). AND gate 730 provides an output signal Max_value superior to Trigger2 that is the result of the comparison of strict superiority between the two inputs.

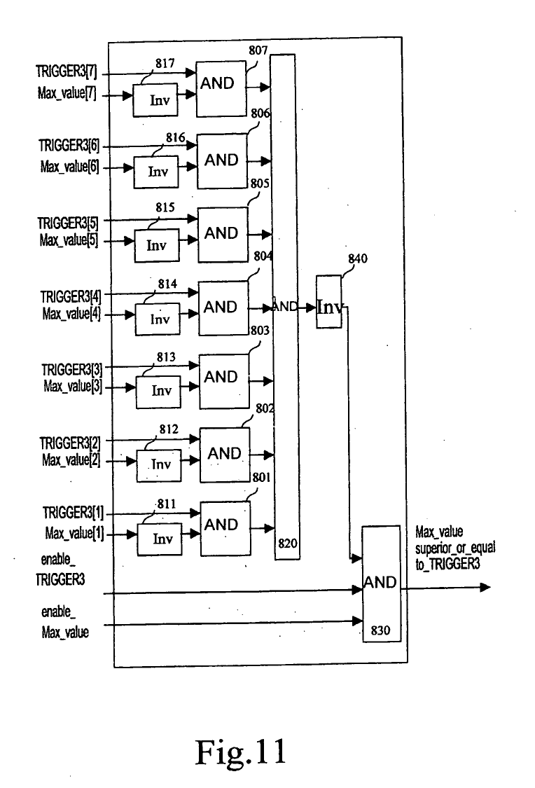

FIG. 11 is an adaptation of FIG. 10 to determine if a value is higher or equal to another. As previously done, each binary element of the transform into T to be processed (Max_value[1] to Max_value[7]) is transmitted to a first input of a AND gate (801 to 807, respectively) whose a second input is connected to the output of an inverter (811 to 817, respectively). The latter has an input, which receives a reference value (trigger3[1] to trigger3[7], respectively). Each AND gate 801 to 806 has its output connected to an input of a AND gate 820 which has an output connected, via an inverter 840 to a first input of a AND gate 830, whose two other inputs receive the two enabling signals of the two values to be compared, namely, enable_max_value and enable_trigger3.

At its output, AND gate 830 provides a signal Max_value_superior to Trigger3 which is positive when the value of Max_value is higher or equal to the reference value Trigger3.

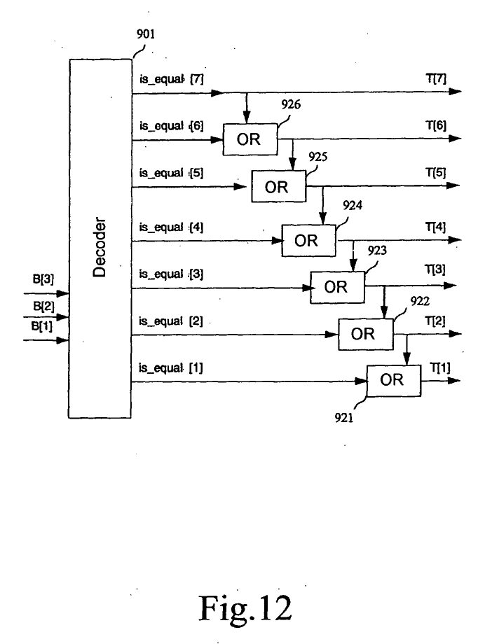

FIG. 12 illustrates, in the form of functional blocks, a possible structure of a circuit providing a conversion into T. Said circuit converts a value coded on three bits B[2] B[1] B[0] to its transform into T, which transform is coded on seven bits T[7] in T[1], respectively. Said circuit comprises a decoder 901 and six logic elements of OR type, respectively 921a 926. Each bit B[2], B[1], and B[0] is transmitted to decoder 901 which outputs seven values, respectively called is_equal[7], is_equal[6], is_equal[5], is_equal[4], is_equal[3], is_equal[2], is_equal[1]. The output is_equal[1] takes the logical value ‘1’ when B[2]=‘0’0 and B[1]=‘0’ and B[0]=‘1’ and, in the contrary case, it takes the logical value ‘0’. Similarly, the outputs is_equal[2], is_equal[3], is_equal[4], is_equal[5], is_equal[6], is_equal[7], take the logical value ‘1’ when triplet B[2]B[1] B[0] takes the value (0, 1, 0), (0, 1, 1), (1, 0, 0), (1, 0, 1), (1, 1, 0) and (1, 1, 1), respectively, and the null value in the contrary case.

Six logic OR elements (921 to 926) are each provided with a first input connected to one of the outputs of decoder 901 (is_equal[1] to is_equal[6], respectively) and with an output providing a signal T(1) to T(6). A signal T(7) comes directly from the output is_equal[7] of decoder 901. Each OR element (921 to 926) is further provided with a second input which is connected to the one of the outputs T(2) to T(7), respectively.

From this structure, a method of manual optimization or the use of tool for logical synthesis makes it possible to directly produce on silicon electronic devices which provide a very fast conversion into T operation and which have an optimized silicon surface.

It should be clear that the circuit of FIG. 12 is only one example among many and that people qualified in the art will be able, without difficulty, to adapt the invention to any format of data, provided, however, the data constitute a set in which a relation of order is defined.

As it can be seen, the coding of information based on the transform into T operation defined previously, allows the handling of data in a particularly fast way. The man skilled in the art having the benefit of this disclosure will be able to directly adapt the use of this operation and its alternatives to any operation carried out on a collection of data. The implementation of the transform into T operation within a semiconductor circuit increases considerably the data processing speed, in a ratio of 5 when compared to the conventional techniques.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments of the invention, including what is described in the Abstract, is not intended to be exhaustive or to limit the invention to the precise forms disclosed. While specific embodiments of, and examples for, the. invention are described herein for illustrative purposes, various equivalent modifications are possible within the scope of the invention and can be made without deviating from the spirit and scope of the invention.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A device for processing digital data belonging to a set of 2ⁿ codes in which a relation of order is established and in which each of said data has a rank R comprised between 0 and 2ⁿ−1, said devicecomprising:
a conversion circuit for each digital data to be processed, in order to generate a transform that is a binary number composed of 2ⁿ−1 binary elements T[x] with x=1 to 2ⁿ−1
T[2ⁿ−1]T[2ⁿ−2] . . . T[x] . . . T[2]T[1]
wherein T(x)=0 when x is strictly higher than R and T(x)=1 when x is lower or equal to R; and
circuits to receive a result of the conversions and to carry out a digital processing of said result.

2. A device for processing digital data belonging to a set of 2ⁿ codes in which a relation of order is established and in which each of said data has a rank R comprised between 0 and 2ⁿ−1, the device comprising:
a conversion circuit for each digital data to be processed in order to generate a transform that is a binary number composed of 2ⁿ binary elements T[x] with x=0 to 2ⁿ−1:
T[2ⁿ−1]T[2ⁿ−2] . . . T[x] . . . T[1]T[0]
wherein T(x)=0 when x is strictly higher than R and T(x)=1 when x is lower or equal to R; and
circuits to receive a result of the conversions and to carry out a digital processing of said result.

3. A device according to claim 1, characterized in that said digital processing is a Boolean OR carried out in bit-serial way on bits of same index of the transformed data and followed by a conversion which is a reverse of said transform, in order to read out a maximum value of a set of digital values.

4. A device according to claim 3 wherein the read out of said maximum value is followed by a comparison with another value.

5. A device according to claim 2 wherein said digital processing is a Boolean AND, carried out in a bit-serial way on bits of same index of the transformed data and followed by a conversion which is a reverse of said transform, in order to read out a minimum value of a set of digital values.

6. A device according to claim 5 wherein the read out of said minimum value is followed by a comparison with another value.

7. A device for processing digital data belonging to a set of 2ⁿ codes in which a relation of order is established and in which each of said data has a rank R comprised between 0 and 2ⁿ−1, said device comprising:
a conversion circuit for each digital data to be processed, in order to generate a transform that is a binary number composed of 2ⁿ−1 binary elements T[x] with x=1 to 2ⁿ−1
T[2ⁿ−1]T[2ⁿ−2] . . . T[x] . . . T[2]T[1]
wherein T(x)=1 when x is strictly higher than R and T(x)=0 when x is lower or equal to R; and
circuits to receive a result of the conversions and to carry out a digital processing of said result

8. A device for processing digital data belonging to a set of 2ⁿ codes in which a relation of order is established and in which each of said data has a rank R comprised between 0 and 2ⁿ−1, said device comprising:
a conversion circuit for each digital data to be processed, in order to generate a transform that is a binary number composed of 2ⁿ binary elements T[x] with x=0 to 2ⁿ−1
T[2ⁿ−1]T[2ⁿ−2] . . . T[x] . . . T[1]T[0]
In which T(x)=1 when x is strictly higher than R and T(x)=0 when x is lower or equal to R; and
circuits to receive a result of the conversions and to carry out a digital processing of said result.

9. A device according to claim 7 wherein said digital processing is a Boolean AND, carried out in a bit-serial way on bits of same index of the transformed data and followed by a conversion which is a reverse of said transform, in order to read out a maximum value of a set of digital values.

10. A device according to claim 9 wherein the read out of said maximum value is followed by a comparison with another value.

11. A device according to claim 8 wherein said digital processing is a Boolean OR, carried out in a bit-serial way on bits of same index of the transformed data and followed by a conversion which is a reverse of said transform, in order to read out a minimum value of a set of digital values.

12. A device according to claim 11 wherein the read out of said minimum value is followed by a comparison with another value.

13. A device according to claim 8 wherein the original code of the digital data to process is of the signed type, not signed, Gray, Johnson or includes a mantissa and an exponent.

14. A device according to claim 7 wherein said transform is applied only to a sub-group of binary elements of each data, in order to process in sequence various parts of each data.

15. A device for reading out a maximum among a set of digital data belonging to a set of 2ⁿ codes in which a relation of order is established and for which each of said data has a rank R comprised between 0 and 2ⁿ−1, said device comprising:
a circuit to represent each one of said digital data under a form of a code made up of 2ⁿ−1 binary elements T[x] with x=1 to 2ⁿ−1:
T[2ⁿ−1]T[2ⁿ−2] . . . T[x] . . . T[2]T[1]
wherein T(x)=0 when x is strictly higher than R and T(x)=1 when x is lower or equal to R; and
logic circuits to carry out a logical OR in a bit-serial way on bits of same index of said digital data, in order to read out the maximum of said set of digital data.

16. A device for reading out a maximum among a set of digital data belonging to a set of 2ⁿ codes in which a relation of order is established and for which each of said data has a rank R comprised between 0 and 2ⁿ−1, said device comprising:
a circuit to represent each one of said digital data under a form of a code made up of 2ⁿ binary elements T[x] with x=0 to 2ⁿ−1:
T[2ⁿ−1]T[2ⁿ−2] . . . T[x] . . . T[1]T[0]
wherein T(x)=0 when x is strictly higher than R and T(x)=1 when x is lower or equal to R; and
logic circuits to carry out a logical OR in a bit-serial way on bits of same index of said digital data, in order to read out the maximum of said set of digital data.

17. A device for reading out a minimum among a set of digital data belonging to a set of 2ⁿ codes in which a relation of order is established and for which each of said data has a rank R comprised between 0 and 2ⁿ−1, said device comprising:
a circuit to represent each one of said digital data under a form of a code made up of 2ⁿ−1 binary elements T[x] with x=1 to 2ⁿ−1:
T[2ⁿ−1]T[2ⁿ−2] . . . T[x] . . . T[2]T[1]
wherein T(x)=0 when x is strictly higher than R and T(x)=1 when x is lower or equal to R; and
logic circuits to carry out a logical AND in a bit-serial way on bits of same index of said digital data, in order to read out the minimum of said set of digital data.

18. A device for reading out a minimum among a set of digital data belonging to a set of 2ⁿ codes in which a relation of order is established and for which each of said data has a rank R comprised between 0 and 2ⁿ−1, said device comprising:
a circuit to represent each one of said digital data under a form of a code made up of 2ⁿ binary elements T[x] with x=0 to 2ⁿ−1:
T[2ⁿ−1]T[2ⁿ−2] . . . T[x] . . . T[1]T[0]
wherein T(x)=0 when x is strictly higher than R and T(x)=1 when x is lower or equal to R; and
logic circuits to carry out a logical AND in a bit-serial way on bits of same index of said digital data, in order to read out the minimum of said set of digital data.

19. A device for reading out a maximum among a set of digital data belonging to a set of 2ⁿ codes in which a relation of order is established and for which each of said data has a rank R comprised between 0 and 2ⁿ−1, said device comprising:
a circuit to represent each one of said digital data under a form of a code made up of 2ⁿ−1 binary elements T[x] with x=1 to 2ⁿ−1:
T[2ⁿ−1]T[2ⁿ−2] . . . T[x] . . . T[2]T[1]
wherein T(x)=1 when x is strictly higher than R and T(x)=0 when x is lower or equal to R; and
logic circuits to carry out a logical AND in a bit-serial way on bits of same index of said digital data, in order to read out the maximum of said set of digital data.

20. A device for reading out a maximum among a set of digital data belonging to a set of 2ⁿ codes in which a relation of order is established and for which each of said data has a rank R comprised between 0 and 2ⁿ−1, said device comprising:
a circuit to represent each one of said digital data under a form of a code made up of 2ⁿ binary elements T[x] with x=0 to 2ⁿ−1:
T[2ⁿ−1]T[2ⁿ−2] . . . T[x] . . . T[1]T[0]
wherein T(x)=1 when x is strictly higher than R and T(x)=0 when x is lower or equal to R; and
logic circuits to carry out a logical AND in a bit-serial way on bits of same index of said digital data, in order to read out the maximum of said set of digital data.

21. A device for reading out a minimum among a set of digital data belonging to a set of 2ⁿ codes in which a relation of order is established and for which each of said data has a rank R comprised between 0 and 2ⁿ−1, said device comprising:
a circuit to represent each one of said digital data under a form of a code made up of 2ⁿ−1 binary elements T[x] with x=1 to 2ⁿ−1:
T[2ⁿ−1]T[2ⁿ−2] . . . T[x] . . . T[2]T[1]
wherein T(x)=1 when x is strictly higher than R and T(x)=0 when x is lower or equal to R; and
logic circuits to carry out a logical OR in a bit-serial way on bits of same index of said digital data, in order to read out the minimum of said set of digital data.

22. A device for reading out a minimum among a set of digital data belonging to a set of 2ⁿ codes in which a relation of order is established and for which each of said data has a rank R comprised between 0 and 2ⁿ−1, said device comprising:
a circuit to represent each one of said digital data under a form of a code made up of 2ⁿ binary elements T[x] with x=0 to 2ⁿ−1:
T[2ⁿ−1]T[2ⁿ−2] . . . T[x] . . . T[1]T[0]
wherein T(x)=1 when x is strictly higher than R and T(x)=0 when x is lower or equal to R; and
logic circuits to carry out a logical OR in a bit-serial way on bits of same index of said digital data, in order to read out the minimum of said set of digital data.

23. An apparatus, comprising:
a conversion circuit to receive digital data belonging to a set of codes in which a relation of order is established and in which each of the digital data has a rank, the conversion circuit being capable to transform the received digital data into a binary number having binary elements whose values are based at least in part on a value of the rank; and
a processing circuit coupled to the conversion circuit to receive the digital data that has been transformed to the binary number and to generate a result therefrom.

24. The apparatus of claim 23 wherein the conversion circuit includes a plurality of conversion units, each being capable to transform their respective digital data from the set into a binary number.

25. The apparatus of claim 23 wherein the processing circuit includes:
a first unit coupled to the conversion circuit to apply a logical operation on binary numbers received from the conversion circuit to generate at least one output therefrom; and
a second unit coupled to the first unit to perform a reverse transform on the at least one output from the first unit to generate the result.

26. The apparatus of claim 25 wherein the logical operation comprises a logical OR operation carried out in a bit-serial manner on bits of the binary numbers of same index.

27. The apparatus of claim 25 wherein the logical operation comprises a logical AND operation carried out in a bit-serial manner on bits of the binary numbers of same index.

28. The apparatus of claim 23 wherein the result includes a minimum value of the set of digital data.

29. The apparatus of claim 23 wherein the result includes a maximum value of the set of digital data.

30. The apparatus of claim 23, further comprising at least another circuit coupled to the processing circuit to compare the result with another value.

31. A method, comprising:
receiving digital data belonging to a set of codes in which a relation of order is established and in which each of the digital data has a rank;
transforming each of the received digital data into a binary number having binary elements whose values are based at least in part on a value of the rank; and
processing the digital data that has been transformed into the binary numbers to generate a result therefrom.

32. The method of claim 31 wherein processing the digital data that has been transformed into the binary numbers includes:
applying a logical operation on the binary numbers to generate at least one output therefrom; and
performing a reverse transform on the at least one output to generate the result.

33. The method of claim 32 wherein applying the logical operation includes applying a logical OR operation in a bit-serial manner on bits of the binary numbers of same index.

34. The method of claim 32 wherein applying the logical operation includes applying a logical AND operation in a bit-serial manner on bits of the binary numbers of same index.

35. The method of claim 31 wherein generating the result includes at least one of generating a maximum and a minimum value of the set of digital data.

36. The method of claim 31, further comprising comparing the generated result with another value.

37. An apparatus, comprising:
a means for receiving digital data belonging to a set of codes in which a relation of order is established and in which each of the digital data has a rank;
a means for transforming each of the received digital data into a binary number having binary elements whose values are based at least in part on a value of the rank; and
a means for processing the digital data that has been transformed into the binary numbers to generate a result therefrom.

38. The apparatus of claim 37 wherein the means for processing the digital data that has been transformed into the binary numbers includes:
a means for applying a logical operation on the binary numbers to generate at least one output therefrom; and
a means for performing a reverse transform on the at least one output to generate the result.

39. The apparatus of claim 38 wherein the means for applying the logical operation includes at least one of a means for applying a logical OR operation and a logical AND operation in a bit-serial manner on bits of the binary numbers of same index.

40. The apparatus of claim 38 wherein the means for processing the digital data to generate the result includes at least one of a means for generating a maximum and a minimum value of the set of digital data.

41. The apparatus of claim 38, further comprising a means for comparing the generated result with another value.

42. A device according to claim 2 wherein said digital processing is a Boolean OR, carried out in bit-serial way on the bits of same index of the transformed data and followed by a conversion which is the reverse of said transform, in order to read out the maximum value of a set of digital values.

43. A device according to claim 1 wherein said digital processing is a Boolean AND, carried out in a bit-serial way on the bits of same index of the transformed data and followed by a conversion which is the reverse of said transform, in order to read out the minimum value of a set of digital values.

44. A device according to claim 8 wherein said digital processing is a Boolean AND, carried out in a bit-serial way on the bits of same index of the transformed data and followed by a conversion which is the reverse of said transform, in order to read out the maximum value of a set of digital values.

45. A device according to claim 7 wherein said digital processing is a Boolean OR, carried out in a bit-serial way on the bits of same index of the transformed data and followed by a conversion which is the reverse of said transform, in order to read out the minimum value of a set of digital values.

46. A device according to claim 15 wherein said transform is applied only to a sub-group of binary elements of each data, in order to process in sequence various parts of each data.

47. A device according to claim 16 wherein said transform is applied only to a sub-group of binary elements of each data, in order to process in sequence various parts of each data.

48. A device according to claim 17 wherein said transform is applied only to a sub-group of binary elements of each data, in order to process in sequence various parts of each data.

49. A device according to claim 18 wherein said transform is applied only to a sub-group of binary elements of each data, in order to process in sequence various parts of each data.

50. A device according to claim 19 wherein said transform is applied only to a sub-group of binary elements of each data, in order to process in sequence various parts of each data.

51. A device according to claim 20 wherein said transform is applied only to a sub-group of binary elements of each data, in order to process in sequence various parts of each data.

52. A device according to claim 21 wherein said transform is applied only to a sub-group of binary elements of each data, in order to process in sequence various parts of each data.

53. A device according to claim 22 wherein said transform is applied only to a sub-group of binary elements of each data, in order to process in sequence various parts of each data.
